(19) United States
(12) Patent Application Publication
(10) Pub. No.: US 2010/0304947 A1
(43) Pub. Date: Dec. 2, 2010

(54) Paper folding apparatus and image forming system

(75) Inventor: Takahiro Itou, Aichi (JP)

Correspondence Address: HARNESS, DICKEY & PIERCE, P.L.C., P.O. BOX 8910, RESTON, VA, 20195, US

(73) Assignee: Ricoh Company, Limited, Tokyo (JP)

(21) Appl. No.: 12/801,267

(22) Filed: Jun. 1, 2010

(30) Foreign Application Priority Data
May 29, 2009 (JP) JP-2009-130723

(51) Int. Cl. B31F 1/00

(52) U.S. Cl. 493/442

(57) ABSTRACT

A paper folding apparatus performs folding by making an end of the paper abut against a stopper member to set a folding position, and making the paper at the folding position be bitten into a nip between a pair of folding rollers, and can perform the folding of a plurality of sheets of paper. The paper folding apparatus can perform outward three folding by making the paper abut against a second stopper member to set a second folding position, and making the sheets of paper at the second folding position be bitten into a nip between a second pair of folding rollers to perform a second folding. In the second folding operation for performing the outward three folding, the second stopper member is moved to push the paper in a direction of the nip between the second pair of folding rollers.

### CROSS-REFERENCE TO RELATED APPLICATIONS

The present application claims priority to and incorporates by reference the entire contents of Japanese Patent Application No. 2009-130723 filed in Japan on May 29, 2009.

### BACKGROUND OF THE INVENTION

1. Field of the Invention

The present invention relates to a paper folding apparatus that folds paper in various types of folding, and relates to an image forming system that includes the paper folding apparatus.

2. Description of the Related Art

The paper folding apparatus of this type is installed at, for example, the paper ejecting side (downstream side in the direction of paper conveyance) of the image forming apparatus such as a copier, a printer, a facsimile, a plotter, a printing press, and a complex machine including at least one of theses apparatuses, and receives paper on which images are formed by the paper forming apparatus, and performs desired folding such as Z folding and three folding. The paper thus folded is directly ejected, or is conveyed to a post-process apparatus disposed at the further downstream side.

Examples of the folding method include a method comprising of making the end of conveyed paper abut against a movable stopper disposed in a conveying path to set a position where the paper is to be folded, and then causing deflection by making the end of paper abut against the stopper and making the deflection be bitten into a nip between a pair of folding rollers positioned near the deflection to fold the paper.

In addition, known is a method comprising of temporarily stopping conveyed paper, projecting a folding blade usually housed outside of a paper conveying path to a position for folding the paper, and thus making the projecting portion of the paper be bitten into a nip between a pair of folding rollers to fold the paper.

These methods are effective for folding a sheet of paper. However, when a plurality of sheets of paper is overlapped and folded by the former method, only a single sheet of paper nearest the pair of folding rollers out of the overlapped sheets of paper enters the nip between the pair of folding rollers first, and, after that, the remaining subsequent sheet of paper enters the nip between the pair of folding rollers. As a result of this, folding the overlapped paper may cause defective folding.

For example, when “outward three folding” is performed during second folding, only single sheet nearest the pair of folding rollers that performs the second folding, out of a plurality of sheets of paper overlapped is folded first, because a sheet at the first folded side out of the overlapped sheets of paper is in a free state. Because of this, the sheets of paper tend to be not simultaneously folded together while keeping in a state in which the sheets of paper are overlapped, which results in defective folding.

When a plurality of sheets of paper is overlapped and folded by the latter method, the folding blade forcefully pushes the rear of the sheets of paper, which are kept in an overlapped state, in the direction of the nip between the pair of folding rollers. Therefore, the defective folding as described above in which only a single sheet of paper nearest the pair of folding rollers out of the overlapped sheets of paper is folded first, does not occur. However, when a plurality of times of folding is performed on some sheets of paper, for example, in the case of three folding, folding blades for the number of times of folding, and members to drive the blades are required, and thus the increase in cost cannot be avoided. Moreover, while the folding blade is driven, paper is needed to be temporarily stopped, which lowers productivity.

Japanese Patent Application Laid-open No. 2006-327765 and Japanese Patent Application Laid-open No. H6-239527 disclose techniques related to the art of the present invention.

### SUMMARY OF THE INVENTION

It is an object of the present invention to at least partially solve the problems in the conventional technology.

According to an aspect of the present invention there is provided a paper folding apparatus that is connected to a downstream side of an image forming apparatus, to which paper on which an image is formed is conveyed one by one. The paper folding apparatus includes: a mechanism in which folding is performed by making an end of the paper abut against a stopper member to set a folding position, and making the paper at the folding position be bitten into a nip between a pair of folding rollers; and which is capable of performing the folding of equal to or more than two sheets of paper by making the sheets of paper stay, and by making the sheets of paper thus stayed be bitten into the nip between the pair of folding rollers while keeping a state in which the sheets of paper are overlapped; and a mechanism in which outward three folding is capable of being performed by making the paper, which is in a state in which the sheets of paper to which first folding is performed are overlapped, abut against a second stopper member to set a second folding position, and making the sheets of paper at the second folding position be bitten into a nip between a second pair of folding rollers to fold the paper, wherein in a second folding operation for performing the outward three folding, the second stopper member is moved to push the paper in a direction of the nip between the second pair of folding rollers after the paper abuts against the second stopper member.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic of a paper folding apparatus according to an embodiment of the present invention;

FIGS. 2A to 2F are schematics of respective folding methods;

FIG. 3 is a schematic illustrating a state where the end of a plurality of sheets of paper abuts against a stopper member to be positioned at a folding position, in the case of outward three folding;

FIG. 4 is a schematic illustrating a state where a folding blade is driven to push the paper into a nip between a pair of folding rollers;

FIG. 5 is a schematic illustrating a state where the paper is bitten into the nip between the pair of folding rollers to perform first folding;

FIG. 6 is a schematic illustrating a state where the paper folded abuts against a second stopper member;

FIG. 7 is a schematic illustrating a state where the deflected portion of the paper enters the nip between a second pair of folding rollers;

FIG. 8 is a schematic illustrating a state where the deflected portions of three sheets of paper enter the nip between the second pair of folding rollers;

FIG. 9 is a schematic illustrating a state of three sheets of paper before second folding is performed;

FIG. 10 is a schematic illustrating a state of three sheets of paper before the second folding is performed, and illustrating a malfunction in which a sheet of paper nearest to the second pair of folding rollers enters the nip first;

FIG. 11 is a schematic illustrating a malfunction in which a sheet of paper nearest to the second pair of folding rollers enters the nip first;

FIG. 12 is a schematic illustrating a state where the second stopper member is moved to push paper into the nip between the second pair of folding rollers;

FIG. 13 is a schematic illustrating a state where the end of the paper is shifted (retracted) from a folded position in a predetermined amount;

FIG. 14 is a schematic illustrating a state where the end of the paper projects from the folded position; and

FIG. 15 is a flowchart illustrating a control operation.

### DETAILED DESCRIPTION OF THE PREFERRED EMBODIMENTS

An embodiment according to the present invention is described below with reference to the accompanying drawings.

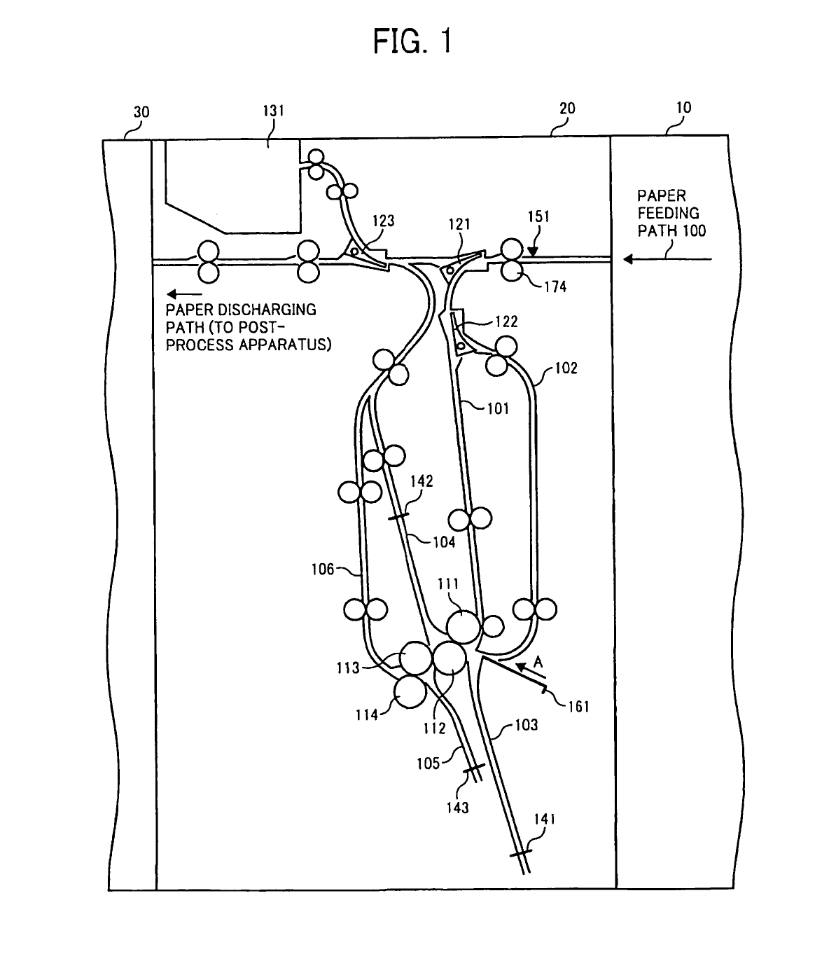

FIG. 1 is a layout of the whole of an image forming system including a paper folding apparatus according to the embodiment of the present invention. A paper folding apparatus 20 is connected to the downstream side (subsequent stage), that is, the paper ejecting side, of an image forming apparatus 10, and a post-process apparatus 30 is connected to the subsequent stage of the paper folding apparatus 20.

Paper on which images are formed, conveyed from the image forming apparatus 10 at the upstream side is conveyed from a paper feeding path 100 to the paper folding apparatus 20.

When paper is conveyed without being folded to a post-process apparatus at the downstream side, the paper is directly ejected from a paper discharging path by a first switching claw 121 and a third switching claw 123. When folding is performed, paper is guided to each conveying path inside of the paper folding apparatus 20 by the first switching claw 121 to perform each folding operation.

The outline of a folding operation in each folding method is described bellow based on FIG. 1.

Z Folding

Paper is guided to a second conveying path 102 by the first switching claw 121 and a second switching claw 122, and passes through a nip between a first folding roller 111 and a second folding roller 112. The end of the paper abuts against a second stopper 142 serving as a second stopper member that is disposed at a fourth conveying path 104 and is movable to a folding position. The thus formed deflected portion of the paper is made to enter a nip between the second folding roller 112 and a third folding roller 113 to perform first folding, and then the paper is conveyed to a fifth conveying path 105. In this context, the second stopper 142 “being movable to a folding position” means that the second stopper 142 is movable to a position for positioning the paper such that the paper will be folded at a predetermined position (hereinafter, similar expressions are used to express the similar meaning).

The end of the paper abuts against a third stopper 143 that is disposed at the fifth conveying path 105 and is movable to a folding position. The thus formed deflected portion of the paper is made to enter a nip between the third folding roller 113 and a fourth folding roller 114 to perform second folding to complete Z folding.

After the completion of the folding, the paper is guided to a sixth conveying path 106 and is ejected to a tray 131 or the post-process apparatus 30 by the third switching claw 123.

Two Folding

Paper is guided to a first conveying path 101 by the first switching claw 121. The end of the paper abuts against a first stopper 141 that is disposed at a third conveying path 103 and is movable to a folding position. The deflected portion of the paper is made to enter the nip between the first folding roller 111 and the second folding roller 112 to perform first folding to complete two folding.

After the completion of the folding, the paper does not enter the fourth conveying path 104, passes through the nip between the second folding roller 112 and the third folding roller 113, and the nip between the third folding roller 113 and the fourth folding roller 114. Subsequently, the paper is guided to the sixth conveying path 106, and is ejected to the tray 131 or the post-process apparatus 30 by the third switching claw 123.

Outward Three Folding, Inward Three Folding, and Simple Four Folding

Paper is guided to the first conveying path 101 by the first switching claw 121. The end of the paper abuts against the first stopper 141 that is disposed at the third conveying path 103 and is movable to a folding position. The deflected portion of the paper is made to enter the nip between the first folding roller 111 and the second folding roller 112 to perform first folding, and then the paper is conveyed to the fourth conveying path 104. The first folding roller 111 and the second folding roller 112 constitute a pair of folding rollers.

The end of the paper abuts against the second stopper 142 that is disposed at the fourth conveying path 104 and is movable to a folding position. The thus formed deflected portion of the paper is made to enter the nip between the second folding roller 112 and the third folding roller 113 to perform second folding to complete the folding. The second folding roller 112 and the third folding roller 113 constitute a second pair of folding rollers.

After the completion of the folding, the paper does not enter the fifth conveying path 105, passes through the nip between the third folding roller 113 and the fourth folding roller 114, is guided to the sixth conveying path 106, and is ejected to the tray 131 or the post-process apparatus 30 by the third switching claw 123.

Double-Door Four Folding

Paper is guided to the first conveying path 101 by the first switching claw 121. The end of the paper abuts against the first stopper 141 that is disposed at the third conveying path 103 and is movable to a folding position. The thus formed deflected portion of the paper is made to enter the nip between the first folding roller 111 and the second folding roller 112 to perform first folding, and then the paper is conveyed to the fourth conveying path 104.

The end of the paper abuts against the second stopper 142 that is disposed at the fourth conveying path 104 and is movable to a folding position. The thus formed deflected portion of the paper is made to enter the nip between the second folding roller 112 and the third folding roller 113 to perform second folding, and then the paper is conveyed to the fifth conveying path 105.

The end of the paper abuts against the third stopper 143 that is disposed at the fifth conveying path 105 and is movable to a folding position. The thus formed deflected portion of the paper is made to enter the nip between the third folding roller 113 and the fourth folding roller 114 to perform third folding to complete double-door four folding.

After the completion of the folding, the paper is guided to the sixth conveying path 106, and is ejected to the tray 131 or the post-process apparatus 30 by the third switching claw 123.

Folding Overlapped Sheets of Paper

For an example of folding overlapped sheets of paper, the case of two folding of overlapped three sheets is described.

The first sheet of paper is guided to the first conveying path 101 by the first switching claw 121. The end of the sheet abuts against the first stopper 141 that is disposed at the third conveying path 103 and is movable to a folding position, to stop the paper.

The second and the third sheets of paper are also conveyed through the same path, and eventually the three sheets of paper stay in a state of abutting against the first stopper 141. Subsequently, the three sheets of paper overlapped are made to enter the nip between the first folding roller 111 and the second folding roller 112 by moving a folding blade 161 in a direction of an arrow A, to perform first folding to complete two folding.

After the completion of the folding, the sheets do not enter the fourth conveying path 104, pass through the nip between the second folding roller 112 and the third folding roller 113, and the nip between the third folding roller 113 and the fourth folding roller 114. Subsequently, the paper is guided to the sixth conveying path 106, and is ejected to the tray 131 or the post-process apparatus 30 by the third switching claw 123.

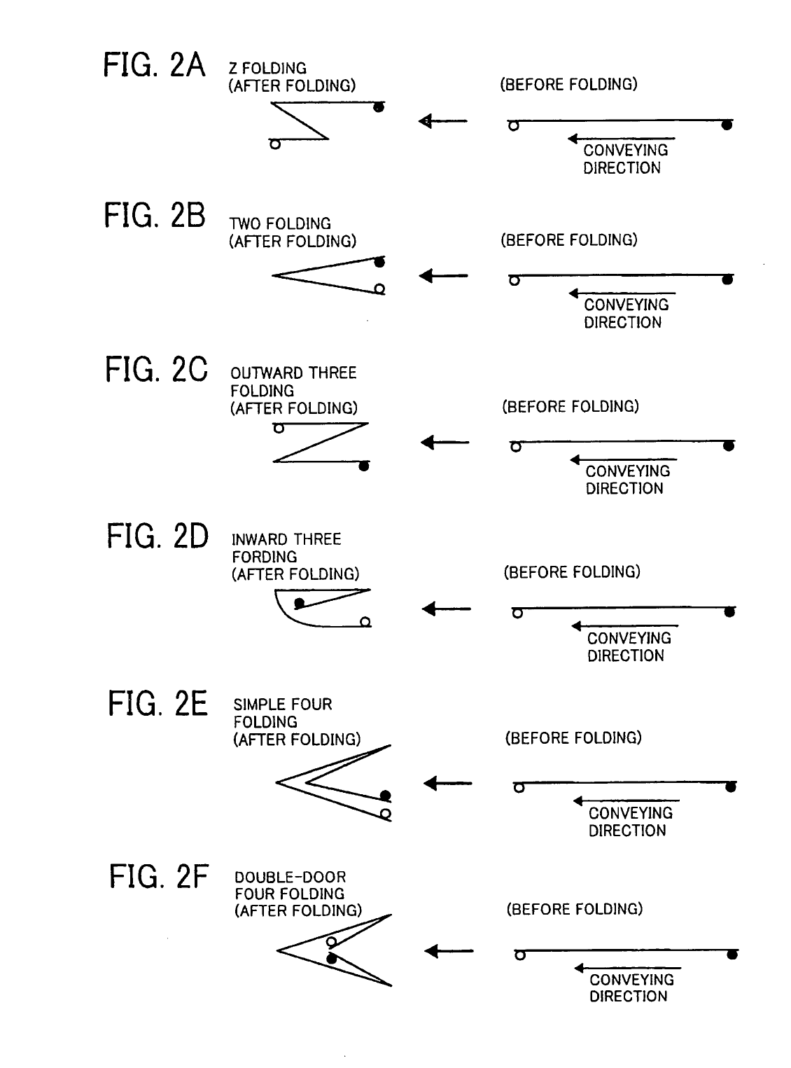

FIGS. 2A to 2F are schematics of paper after folding in the respective folding modes. For the convenience of understanding the state after folding, the front end and the back end of the paper are marked with a white circle and a black circle, respectively.

FIG. 2A indicates “Z folding”, FIG. 2B indicates “two folding”, FIG. 2C indicates “outward three folding” that is intended to be solved by the embodiment of the present invention, FIG. 2D indicates “inward three folding”, FIG. 2E indicates “simple four folding”, and FIG. 2F indicates “double-door four folding”.

“Outward three folding” in the case of folding overlapped three sheets is described below.

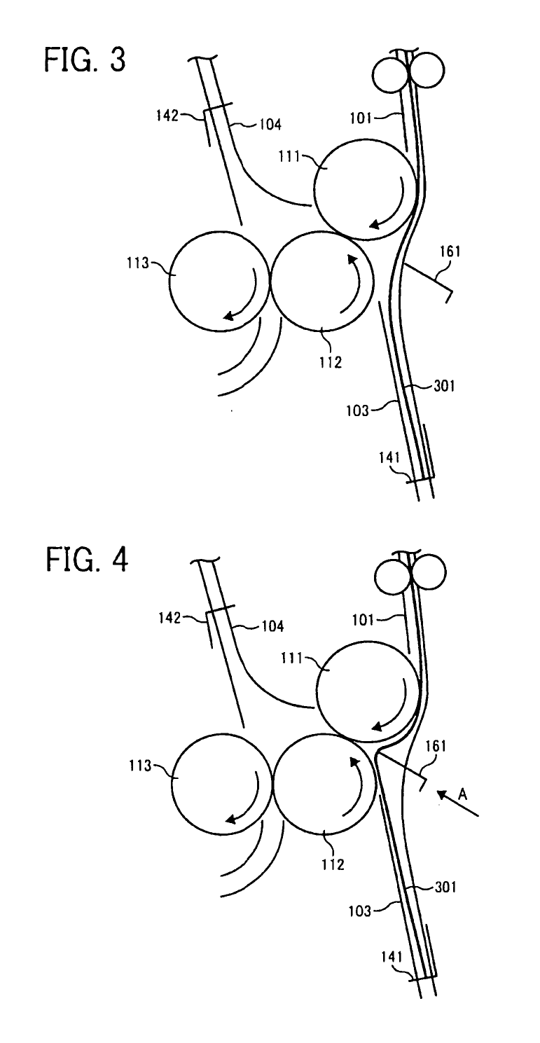

FIG. 3 is a schematic illustrating a state where three sheets of paper 301 overlapped stay in a state of abutting against the first stopper 141 disposed at, the third conveying path 103.

The operation until the three sheets of paper 301 stay is the same as the operation content described in the above section entitled “Folding overlapped sheets of paper”, and three sheets of paper of FIG. 3 is illustrated in one line.

As illustrated in FIG. 4, the folding blade 161 positioned outside of a conveying path while paper is conveyed, is moved by a driving unit (not illustrated) in a direction of the arrow A, and pushes the three sheets of paper 301 stayed to make the overlapped three sheets of paper 301 enter the nip between the first folding roller 111 and the second folding roller 112. Then, as illustrated in FIG. 5, first folding is performed.

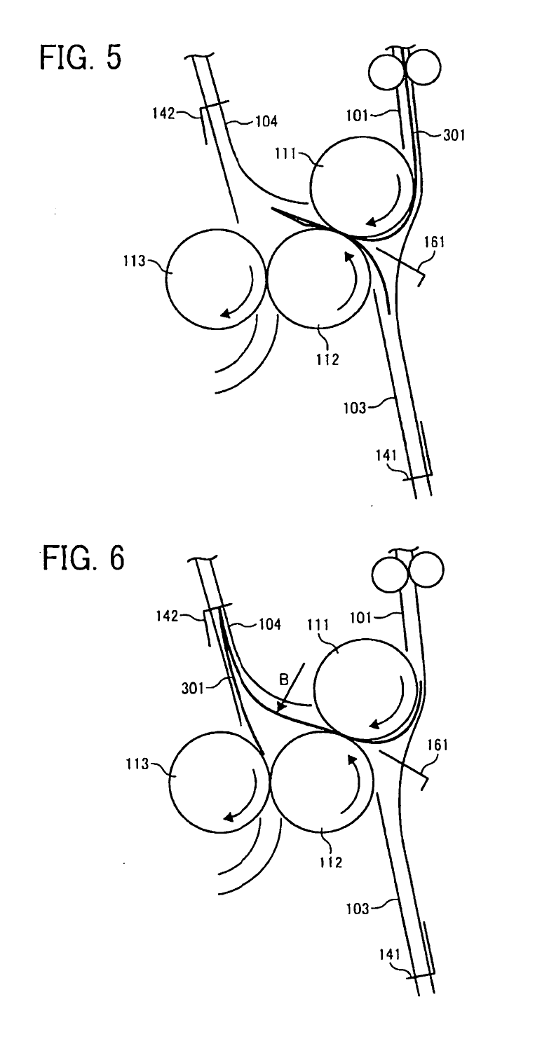

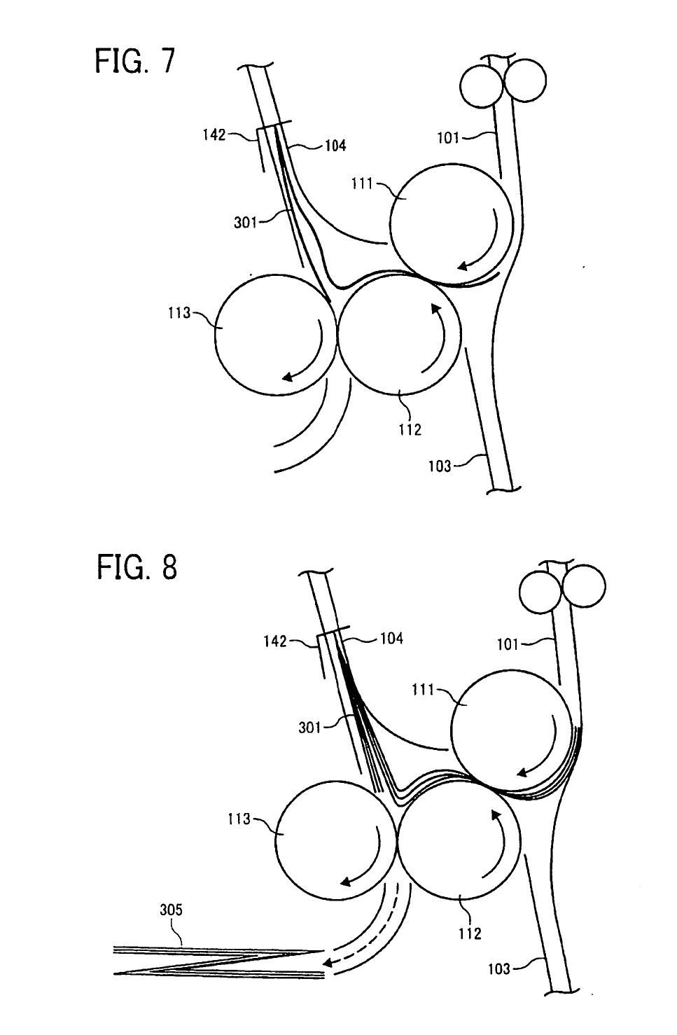

Subsequently, as illustrated in FIG. 6, the folded end of the sheets of paper 301 abut against the second stopper 142 in the fourth conveying path 104, and the sheets of paper are further conveyed by the first folding roller 111 and the second folding roller 112. Because of this, the deflection of the sheets of paper 301 occurs in a direction of an arrow B. As illustrated in FIG. 7, the deflection moves closer to the nip between the second folding roller 112 and the third folding roller 113.

Although in FIGS. 3 to 7, the three sheets of paper are illustrated in one thick line, FIG. 8 indicates the three sheets of paper 301 of FIG. 7 illustrated by one sheet each.

Subsequently, the ends of the three sheets of paper and the deflected portion, at which the three sheets are overlapped, enter the nip between the second folding roller 112 and the third folding roller 113 to perform second folding to complete outward three folding 305 in the case of overlapped three sheets.

However, during this second folding, the ends of the three sheets of paper and the overlapped three sheets at the deflected portion may not enter the nip between the second folding roller 112 and the third folding roller 113 at the same time to cause defective folding.

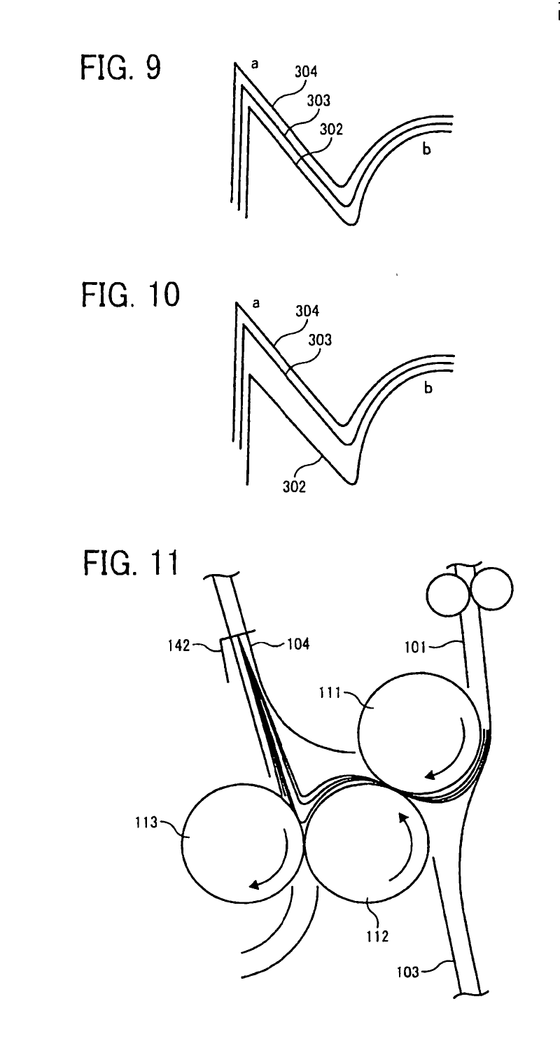

FIGS. 9 and 10 are schematics of three sheets of paper 302, 303, 304, illustrated from the side, before they enter the nip between the second folding roller 112 and the third folding roller 113 during the second folding.

In FIG. 9, before the ends of the three sheets of paper and the deflected portion, at which the three sheets are overlapped, enter the nip between the second folding roller 112 and the third folding roller 113, at the b side, the three sheets of paper are bitten by the first folding roller 111 and the second folding roller 112, and therefore are not separated from each other.

However, at the a side, the three sheets of paper are in a state of abutting against the second stopper 142 in the fourth conveying path 104 and there is no mechanism by which the overlapped sheets of paper are held as in the b side. Therefore, the sheets of paper are in a free state, and thus tend to separate from each other.

As illustrated in FIGS. 10 and 11, when the sheets are separated at the a side, only a sheet of paper 302 nearest to the nip between the second folding roller 112 and the third folding roller 113 is prone to enter the nip between the second folding roller 112 and the third folding roller 113. The remaining two sheets of paper 303, 304 overlapped enter after the sheet of paper 302 enters. As a result of this, the folds of three sheets may not be matched to cause defective folding.

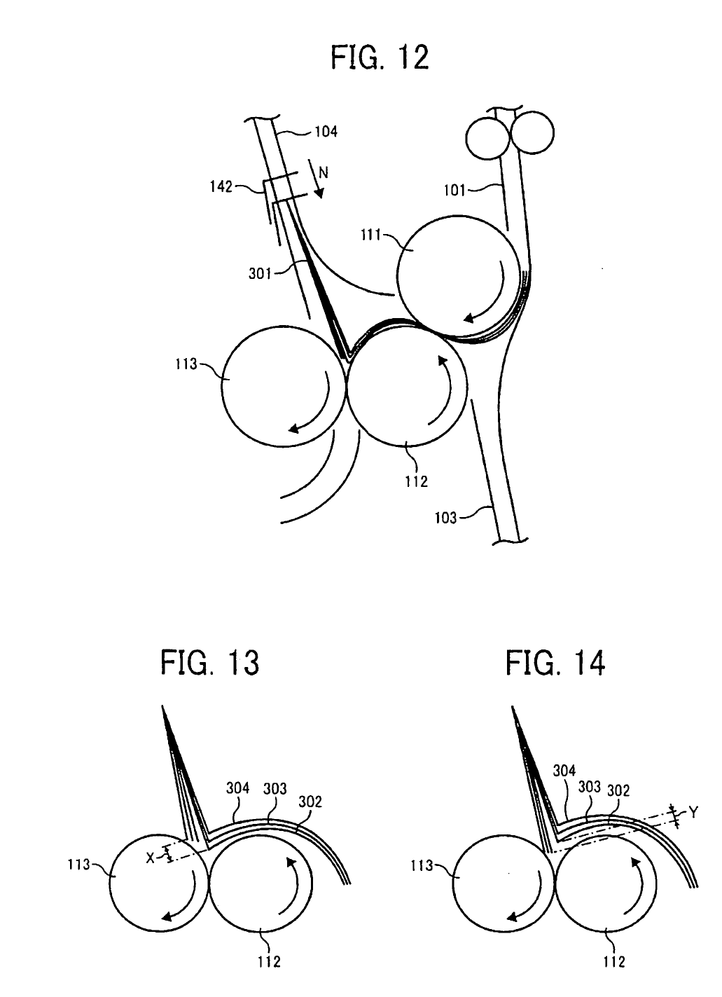

For preventing the defective folding, in the embodiment of the present invention, as illustrated in FIG. 12, when the ends and the deflected portion, at which the three sheets are overlapped, of the three sheets of paper 301 abutting against the second stopper 142 inside of the fourth conveying path 104 enter the nip between the second folding roller 112 and the third folding roller 113, the three sheets of paper are moved in a direction of an arrow N to be pushed by the second stopper 142 at a speed same as a paper folding speed (a folding roller rotation speed=a folding linear speed). This movement prevents the sheet of paper 302 nearest to the nip between the second folding roller 112 and the third folding roller 113 from entering the nip alone, and enables the three sheets of paper to enter the nip between the second pair of folding rollers while keeping a state where the three sheets are overlapped.

The second stopper 142 is moved by a driving unit (not illustrated).

During the operation, in which the sheets of paper abutting against the second stopper 142 are pushed into the nip portion between the second folding roller 112 and the third folding roller 113 by the second stopper 142, from the time the paper abuts to the time the paper starts to be pushed, for example, when the paper is thin paper, the paper is easily deflected. Therefore, in this case, immediately after the paper abuts, a paper pushing operation is performed.

On the other hand, when the paper is thick paper, the paper is hard to be deflected. Therefore, in this case, for ensuring further deflection of the paper, after the paper abuts, the paper pushing operation is not performed immediately, and the second stopper 142 is stopped for a certain period of time. By this operation, the paper is conveyed also during this period to the inside of the fourth conveying path 104, and therefore, further deflection of the paper is ensured and then the paper pushing operation is performed.

As described above, depending on the difference of the type of paper (the thickness of paper), a difference in stopping time of the second stopper 142 may be provided.

The certain period of time in this case is determined depending on the desired extent of the deflection of the paper. The information of the type of paper (the thickness of paper) conveyed to the paper folding apparatus 20 is transmitted from the image forming apparatus 10 at the upstream side through an interface cable (not illustrated) to the paper folding apparatus 20.

When the three sheets of paper 301 overlapped are bitten into the nip between the second folding roller 112 and the third folding roller 113, at the a side, the sheets of paper in the unsupported state becomes supported. Because of this, the pushing operation by the second stopper 142 becomes unneeded, and the second stopper 142 stops.

The stopped second stopper 142 returns to its original abutting position before the following three sheets of paper overlapped enter the inside of the fourth conveying path 104 to prepare for the entering of the following paper.

The appropriate stop operation of the second stopper 142 after the paper pushing operation can be determined by detecting (judging) that the sheets of paper pushed are gotten into the nip between the second pair of folding rollers (the second folding roller 112 and the third folding roller 113) based on the time from the start of paper pushing until the paper is gotten into the nip between the second pair of folding rollers, which is calculated from a paper pushing speed, and a distance from the abutting position of the second stopper 142 (home position) to the nip between the second pair of folding rollers.

The same operation is repeated on paper abutting against the second stopper 142 in a similar manner thereafter.

FIGS. 13 and 14 are schematics illustrating the three sheets of paper 302, 303, 304 overlapped, the second folding roller 112, and the third folding roller 113, when the second folding is performed.

As a result of the experiment in this structure, in FIG. 13, regarding a difference X between the end of the paper and the second folded position, when the difference X exceeds 2 millimeters, only the sheet of paper 302 nearest to the nip between the second folding roller 112 and the third folding roller 113 is prone to enter the nip, as illustrated in FIGS. 10 and 11, which results in defective folding. For this reason, the difference X is preferably equal to or less than 2 millimeters at most.

As a result of the experiment in this structure, in FIG. 14, regarding a difference Y between the end of the paper and the second folded position, when the end of the paper projects from the second folded position (difference Y), the pair of rollers is prone to convey only the first sheet of paper at the end of the paper first. This may cause defective folding, and thus preferably, the difference Y is not caused (projection is not provided).

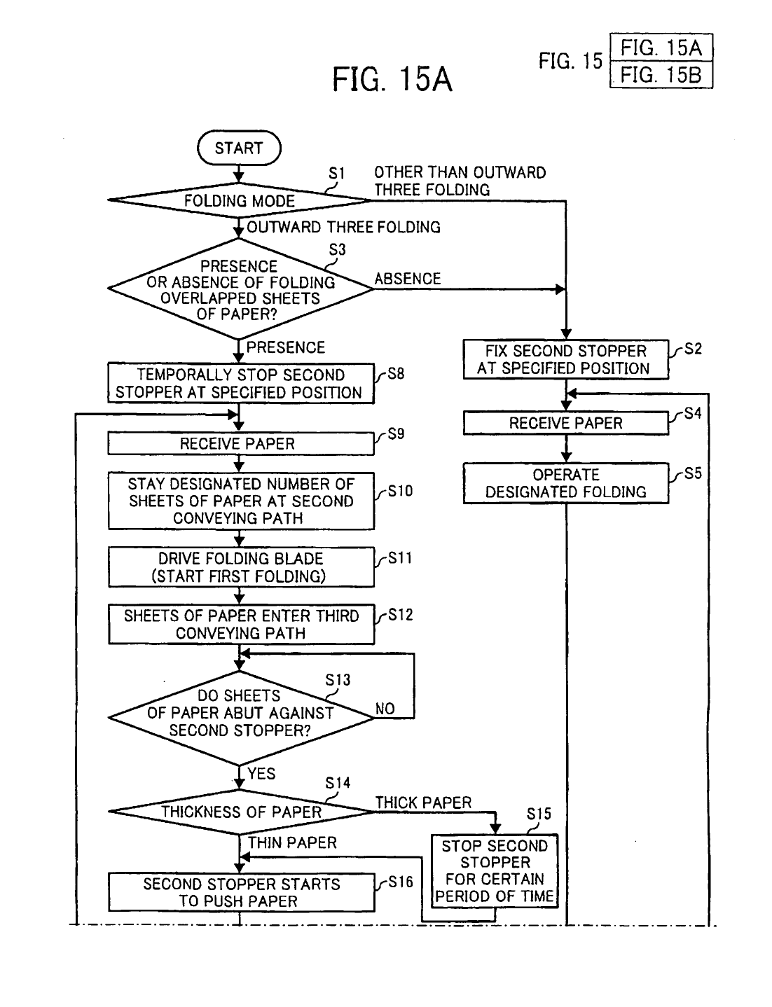

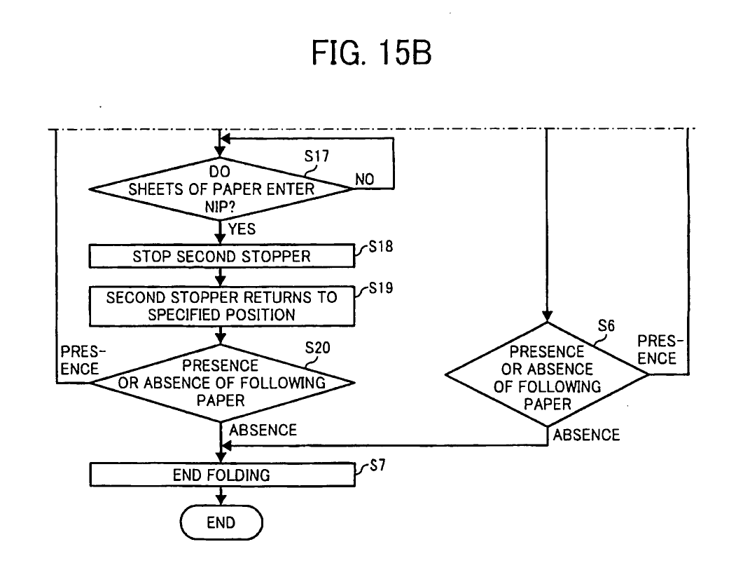

The paper pushing operation performed by the second stopper 142 in the direction to the nip between the second folding roller 112 and the third folding roller 113 is described based on the flowchart of FIG. 15.

When the operation starts, a selected folding mode is judged (S1).

If the mode is other than the outward three folding, a second stopper moves to a specified position (predetermined position) suitable for the selected folding mode and paper to be fold, and stops at the position until the end of the folding (S2).

If the mode is the outward three folding; whether the outward three folding is performed on a plurality of sheets overlapped is judged (S3). If no sheet is overlapped, the second stopper moves to the specified position suitable for the selected folding mode and the paper to be fold, and stops at the position until the end of the folding (S2). Subsequently, the paper is received (S4), and the operation for designated folding is performed (S5). The paper is ejected from a folding apparatus, and further the presence or absence of need for folding of the following paper is judged (S6). If the result is presence, paper is received again to repeat the folding.

If the result is absence, the folding is ended (S7).

At S3, if it is judged that folding is performed on the overlapped sheets, the second stopper moves to the specified position suitable for the selected folding mode and the paper to be fold, and temporally stops at the position (S8).

Subsequently, the paper is received (S9), and a designated number of sheets of paper are made to stay at a second conveying path (S10) to perform first folding by driving a folding blade (S11).

The folded paper enters a third conveying path (S12), and then whether the deflected portion of the paper abuts against the second stopper is judged (S13). When the paper still does not abut, the system control waits until the paper abuts. When the paper abuts, the thickness of the paper is judged (S14).

If the paper is thick paper, the second stopper is stopped for a certain period of time (optimal time depending on the thickness of paper determined by an experiment in advance) (S15), and subsequently, the second stopper starts to push the paper into a nip portion between the second folding roller 112 and the third folding roller 113 at a speed same as a paper folding linear speed (S16).

If the paper is thin paper, the second stopper starts to push the paper into the nip portion between the second folding roller 112 and the third folding roller 113 at a speed same as the paper folding linear speed, without being stopped for the period of time.

Whether the pushed paper enters the nip between the second folding roller 112 and the third folding roller 113 is judged (S17). When the paper still does not enter, the paper is pushed until it enters, and if the paper enters, the second stopper stops (S18). Second folding is performed on the paper, and then the paper is ejected to the outside of the apparatus.

The second stopper is returned to its initial specified position (S19), and further the presence or absence of need for folding of the following paper is judged (S20). If the result is presence, paper is received again to repeat the folding.

If the result is absence, the folding is ended.

According to the embodiment of the present invention, without increasing a number of folding blades even in a folding mode such as “outward three folding”, defective folding can be suppressed, and folding quality can be enhanced.

A paper pushing speed by the second stopper 142 is preferably the same as a paper folding linear speed. Because of this, defective folding caused by a mismatch of timing of the sheets of paper 301 entering into the nip between the second pair of folding rollers (the second folding roller 112 and the third folding roller 113) for a second folding, due to the difference between the paper folding linear speed and the paper pushing speed, is prevented. As a result, the paper is unfailingly made to enter the nip between the pair of folding rollers for the second folding without malfunction.

A paper pushing operation performed by the second stopper 142 is preferably stopped after the paper pushed is bitten into the nip between the second pair of folding rollers. Without further pushing, the overlapped sheets of paper do not come apart. Further, the second stopper 142 timely completes the paper pushing operation, and thus can be ready to promptly perform the subsequent control on the following paper to be conveyed in the same conveying path 104.

After being moved for paper pushing, the second stopper 142 stopped preferably returns to an initial specified position for setting the second folding position, before the following paper is conveyed in the same conveying path 104. Therefore, there is no need to temporarily stop the conveyance of the following paper in the conveying path 104 until the second stopper 142 returns at the specified position, which results in preventing the productivity from being lowered.

When the outward three folding is performed on a single sheet of paper, the second stopper member preferably does not move. Thereby, folding control in single sheet folding can be simplified.

When the outward three folding is performed on the sheets of paper 301 overlapped, during the second folding operation, an end of the paper preferably enters the nip between the second pair of folding rollers in a state where the end of the paper is shifted from the second folding position towards the second stopper 142 within a certain dimension or in a state where the end of the paper does not project from the second folding position towards the nip between the second pair of folding rollers. This can be realized by controlling the positional relationship between the first stopper 141 and the second stopper 142. This positional relationship is not changed from the start of folding to the end of the folding. Therefore, the same positional relationship can be applied to both of a single sheet folding and a multiple sheets folding, which enables the commonality of the control between the single sheet folding and the multiple sheets folding.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A paper folding apparatus that is connected to a downstream side of an image forming apparatus; to which paper on which an image is formed is conveyed one by one; the paper folding apparatus comprising:
a mechanism in which folding is performed by making an end of the paper abut against a stopper member to set a folding position, and making the paper at the folding position be bitten into a nip between a pair of folding rollers; and which is capable of performing the folding of equal to or more than two sheets of paper by making the sheets of paper stay, and by making the sheets of paper thus stayed be bitten into the nip between the pair of folding rollers while keeping a state in which the sheets of paper are overlapped; and
a mechanism in which outward three folding is capable of being performed by making the paper, which is in a state in which the sheets of paper to which first folding is performed are overlapped, abut against a second stopper member to set a second folding position, and making the sheets of paper at the second folding position be bitten into a nip between a second pair of folding rollers to fold the paper, wherein
in a second folding operation for performing the outward three folding, the second stopper member is moved to push the paper in a direction of the nip between the second pair of folding rollers after the paper abuts against the second stopper member.

2. The paper folding apparatus according to claim 1, wherein a pushing speed in the direction of the nip between the second pair of folding rollers is same as a paper folding linear speed.

3. The paper folding apparatus according to claim 1, wherein a paper pushing operation performed by the second stopper member is stopped at timing judged that the paper pushed is bitten into the nip between the second pair of folding rollers, based on time from start of paper pushing until paper is bitten into the nip between the second pair of folding rollers, the time being calculated from a paper pushing speed by the second stopper member, and a distance from a position of the second stopper member to the nip between the second pair of folding rollers.

4. The paper folding apparatus according to claim 1, wherein after the second stopper member moves and then stops, the second stopper member returns to a predetermined position for setting the second folding position, before following paper is conveyed in a same conveying path.

5. The paper folding apparatus according to claim 1, wherein when the outward three folding is performed on a single sheet of paper, the second stopper member does not move.

6. The paper folding apparatus according to claim 1, wherein when the outward three folding is performed on the sheets of paper overlapped, during the second folding operation, an end of the paper enters the nip between the second pair of folding rollers in a state where the end of the paper is shifted from the second folding position towards the second stopper member within a certain dimension.

7. The paper folding apparatus according to claim 1, wherein when the outward three folding is performed on the sheets of paper overlapped, during the second folding operation, an end of the paper enters the nip between the second pair of folding rollers in a state where the end of the paper does not project from the second folding position towards the nip between the second pair of folding rollers.

8. The paper folding apparatus according to claim 6, wherein when the outward three folding is performed on a single sheet of paper, the paper also enters in a similar state.

9. The paper folding apparatus according to claim 7, wherein when the outward three folding is performed on a single sheet of paper, the paper also enters in a similar state.

10. An image forming system comprising:
a paper forming apparatus that is connected to a downstream side of an image forming apparatus; to which paper on which an image is formed is conveyed one by one; and
the image forming apparatus, wherein
both of which are provided as an integrated body or separated bodies;
the paper folding apparatus comprises:
a mechanism in which in which folding is performed by making an end of the paper abut against a stopper member to set a folding position, and making the paper at the folding position be bitten into a nip between a pair of folding rollers; and which is capable of performing the folding of equal to or more than two sheets of paper by making the sheets of paper stay, and by making the sheets of paper thus stayed be bitten into the nip between a pair of folding rollers while keeping a state in which the equal to or more than two sheets of paper are overlapped; and
a mechanism in which outward three folding is capable of being performed by making the paper, which is in a state in which the sheets of paper to which first folding is performed are overlapped, abut against a second stopper member to set a second folding position, and making the sheets of paper at the second folding position be bitten into a nip between a second pair of folding rollers to fold the paper, wherein
in a second folding operation for performing the outward three folding, the second stopper member is moved to push the paper in a direction of the nip between the second pair of folding rollers after the paper abuts against the second stopper member.
